(19) United States
(12) Patent Application Publication
(10) Pub. No.: US 2011/0310294 A1
(43) Pub. Date: Dec. 22, 2011

(54) Camera Housing

(76) Inventors: Markus Lindgren, Malmo (SE); Björn Hallin, Malmo (SE)

(21) Appl. No.: 13/202,937

(22) PCT Filed: Feb. 23, 2010
(86) PCT No.: PCT/SE2010/050205

§ 371 Date: Aug. 23, 2011

(30) Foreign Application Priority Data
Feb. 24, 2009 (SE) 0900234-6

(51) Int. Cl. H04N 5/225

(52) U.S. Cl. 348/376; 348/E05.024

(57) ABSTRACT

A camera housing capable of carrying camera components and peripherals is provided. The housing includes a front portion, a back portion and an intermediate portion in between. The intermediate portion is formed with an arched recess dimensioned to receive the shoulder of an operator. A straight base line A extends substantially horizontally and defines a top section of the recess in an operating position of the camera housing. The front portion and the back portion substantially are located below line A.

### TECHNICAL FIELD

The invention relates to a camera such as a video camera or other camera for filming moving objects or activities. More specifically the camera is intended to be carried on the shoulder of an operator.

### PRIOR ART

Prior art cameras have been designed in a similar manner for many decades. Basically such cameras are formed as a box with an optical assembly in the front, memory or recording means in the back and shoulder support in a base part. These cameras can be carried by hand or mounted on tripods or on a shoulder mounted camera support. Increased demands on flexibility, presence and speed of production have made shoulder mounted camera supports more and more common.

The camera normally is supported in a standing position when carried on the shoulder mounted camera support. To remain in the desired position the camera normally is supported by both two hands and the right hand cheek of the operator. The camera always is positioned on the right hand side and muscles in the shoulder constantly are used to level and to balance the camera. As a result the shoulder, the back and the arms are heavily loaded. The position of the arms is above the level of the heart leading to a reduced supply of blood to the arms.

An alternative design of cameras is the hand carried camera that has been used for some years. This type of camera is mostly used by amateurs but can be seen also in more professional applications. A major advantage of this camera type is the small size. However, this also is the drawback. A smaller camera is more difficult to stabilize and all functions and controls are arranged more compact so as to suit the smaller size.

As a result most professional photographers keep using the larger cameras because they will provide a more reliable result, in spite of the insufficient ergonomics. Several solutions have been presented to improve the insufficiencies of prior art cameras. Such solutions include the use of accessories and equipment.

The most expensive and probably also the most efficient tool is a so called steady cam. It comprises a harness which is attached to an iso-elastic arm. The operator wears the harness and the arm is connected to an armature which has the camera mounted at one end and a counterbalance weight at the other. The counterbalance may comprise a battery pack and a monitor. The combined weight of the counterbalance and camera means that the armature bears a relatively high inertial mass resulting in an improved stability.

An alternative camera support system comprises a hip belt supporting a vertically extending first arm. A suspension line with a hook is attached to a second support arm. The hook is attached to the camera. The major advantage of such a support system is the low weight and improved ergonomics because most of the weight is carried on the hips of the operator. A disadvantage is lower stability than the steady cam.

Another alternative is a system comprising handles that are mounted in front of the camera body below the lens system. An advantage with this system is that the operator keeps his hands at a lower level and has the weight on both his hands. The obvious drawback is that the operator will not keep his hands on the lens system for adjusting focus and zoom. Instead a second person may be required for these tasks.

One prior art system is disclosed in U.S. Pat. No. 6,056,449. It is a frame assembly comprising a rigid frame a pair of hand grips connected to the frame.

A shoulder platform with an elongated bent frame, a shoulder mount affixed below the frame and a camera mount piece is disclosed in U.S. Pat. No. 6,641,010. A camera mounted on the mount piece can be placed in different positions while keeping the shoulder platform stationary on the operator's shoulder.

U.S. Pat. No. 6,457,880 discloses a camera, a housing and a shoulder support to support the housing on a shoulder. The shoulder support comprises a flexible carrying member attached to the shoulder support by two connecting members at a first end and second end, respectively. The connecting members are movably connected and can be moved towards one and another resulting in a clamping action on the shoulder by the shoulder support.

Prior art systems fail to provide an ergonomic camera system that can be carried and handled by one person only.

### SUMMARY OF THE INVENTION

It is an object of the invention to provide a camera housing that will ensure ergonomic working conditions to a camera operator while at the same time provide a well stabilized camera positioning. The camera housing or camera body in accordance with the invention does not add any restrictions to peripheral equipment.

A main feature of the camera housing in accordance with the invention is that the support surface engaging the shoulder of the operator is provided at a substantial higher position of the camera housing. As a result the camera housing will no longer be standing on the shoulder of the operator but rather hang from the shoulder. The camera housing is formed with an arched recess having a front surface, a bottom surface and a back surface. The front surface will engage the front of the operator's shoulder and the chest while the back surface will engage the back of the operator's shoulder and the back. Most of the weight of the camera housing and accessories attached thereto will be carried by the shoulder through the bottom surface of the camera housing.

The shape of the recess in various embodiments is adapted to the form of a human shoulder and as a result the operator can carry the camera housing with less muscular stress and with higher stability. The size of the recess preferably is sufficient large to accommodate the shoulder of most operators. Inner sides of the recess can be lined with a suitable material that adapts to the size of the shoulder. The front surface preferably is inclined to follow the curvature of the chest while the back surface is only slightly inclined to follow the curvature of the back of the operator.

The camera housing comprises a front portion, a back portion and an intermediate portion in between. The intermediate portion extends substantially horizontally and the front portion and the back portion extend substantially vertically. A central section of the intermediate portion is formed with an indentation formed to provide good ergonomics for the neck and cheek that will be received in the indentation. A main reason for providing the indentation is to bring more of the weight of the camera housing towards the centre of the body, the nodal point of the body. As a result the camera housing will not easily slip of off the shoulder and the working position of the hands will be closer to the body. Furthermore, the camera no longer has to lie close to the ear of the operator, since it will hang from the shoulder.

Another advantage is that the operator will have a full view ahead. In prior art systems the camera will obstruct the view to the right and leave only about 90° . The substantially lower position of the camera housing also will allow the operator to wear a headphone or a headset.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 is a schematic perspective view of one embodiment of a camera housing in accordance with the invention,

FIG. 2 is a schematic front view of the camera housing of FIG. 1,

FIG. 3 is a schematic front view of an alternative embodiment of a camera housing in accordance with the invention,

FIG. 4 is a schematic perspective view of a further alternative embodiment of a camera housing in accordance with the invention, and

FIG. 5 is a schematic perspective view of still a further alternative embodiment of a camera housing in accordance with the invention.

### DETAILED DESCRIPTION

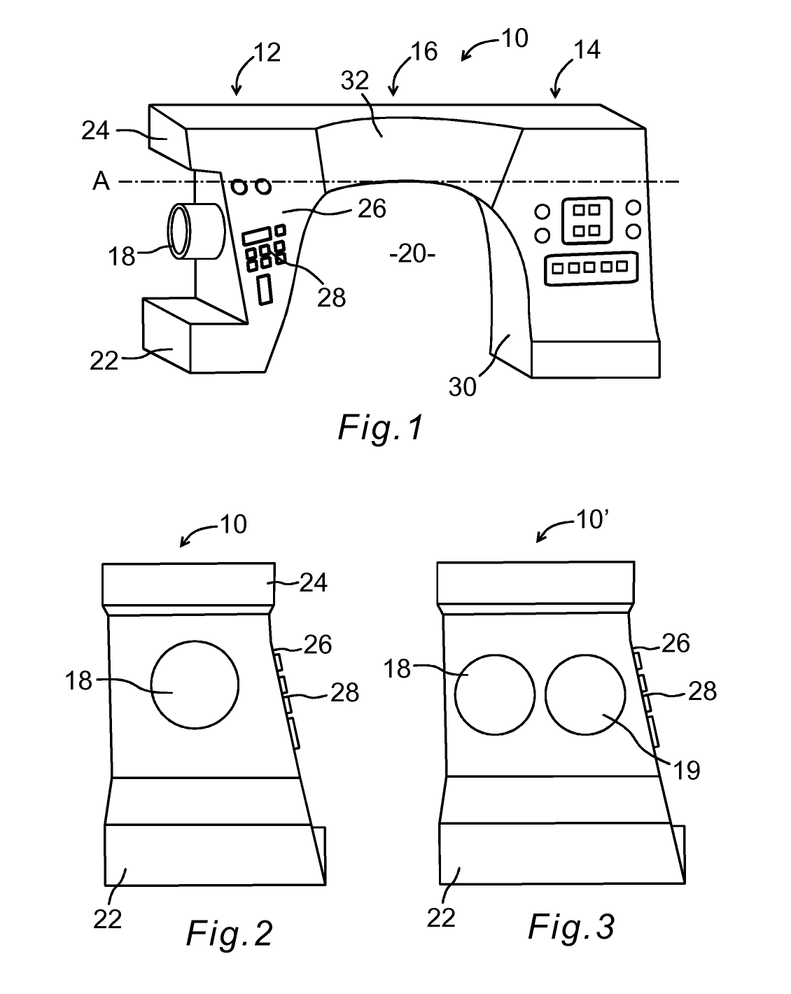

The schematic view in FIG. 1 shows a camera housing 10 comprising a front portion 12, a back portion 14 and an intermediate portion 16. The camera housing 10 is designed to be carried on the right shoulder of an operator which normally is a prerequisite in the industry. The intermediate portion 16 is formed with an arched recess 20 defined also by opposite side edges of the front portion 12 and the back portion 14. A base line A extends horizontally along a top section of the recess 20.

The front portion 12 has a front side where an optical system including a lens 18 is arranged below the base line A. As shown also in FIG. 2 the front portion has a wider base 22 and a slimmer top 24 extending also over the intermediate portion 16 and the back portion 14. An inclined surface 26 connecting the base and the top of the front portion 12 provides an area for controls 28 that are readily reached by the operator when the camera housing is supported by the shoulder of the operator. The controls also will be more visible to the operator.

The wider base 22 also provides more space in the front portion for electronic modules and an optical sensor (not shown) arranged adjacent to the lens 18. The wider base 22 further will increase the weight of the camera housing 10 towards the body centre of the operator and as a result the camera housing will hang more steadily on the shoulder. The weight of the lens 18 and associated means is located below the base line A and also below the location in a prior art camera housing. The lower position of the lens 18 will contribute to better ergonomics and a lower working position of the hands of the operator. The wider base 22 will lower the centre of gravity of the camera housing. Furthermore, the camera housing is more stable when left standing on a flat surface. Also the back portion 14 has a wider lower part 30.

In the embodiment shown in FIG. 1 the intermediate portion 16 has a cut-in portion 32 formed to receive the neck of the operator. The cut-in portion 32 further will move the weight of the camera housing towards the nodal point of the body of the operator. The intermediate portion 16 acts as a connection piece between the optics, the sensor and associated electronics arranged in the front portion 12 and the remaining components of the camera that are provided in the back portion 14.

The back portion 14 of the camera housing 10 including the wider lower part 30 provides a large amount of space for camera electronics. The space is sufficient also to include batteries, storing means and other modules that can be separated from the sensor and optical system of the camera. By arranging heavy components such as the battery in the back portion 14 the camera housing will be balanced and can easily be maintained in the operating position without physical effort. The front portion 12 supports the optical system of the camera which normally also is comparatively heavy.

The base 22 of the front portion and the lower part 30 of the back portion extend at least 7 cm below the base line A. A lens supporting means supporting the lens 18 is provided below the base line A.

The inclined surface 26 of the front portion 12 is shown more clearly in FIG. 2. The wider base 22 and the inclined surface will move the centre of gravity of the camera housing towards the nodal point of the body of the operator. The lens 18 is arranged in a substantially central position in the camera housing. The top 24 is narrower than the base 22. Most of the controls 28 extend from the inclined surface 26.

The first alternative embodiment of a camera housing 10′ shown in FIG. 3 has most components and construction details in common with the embodiment shown in FIG. 1 and FIG. 2. The main difference is a double arrangement of optics and associated electronics. The alternative camera housing 10′ comprises a first lens 18′ and a second lens 19. Said first lens 18′ and said second lens 19 are used to provide a three dimensional function of the camera.

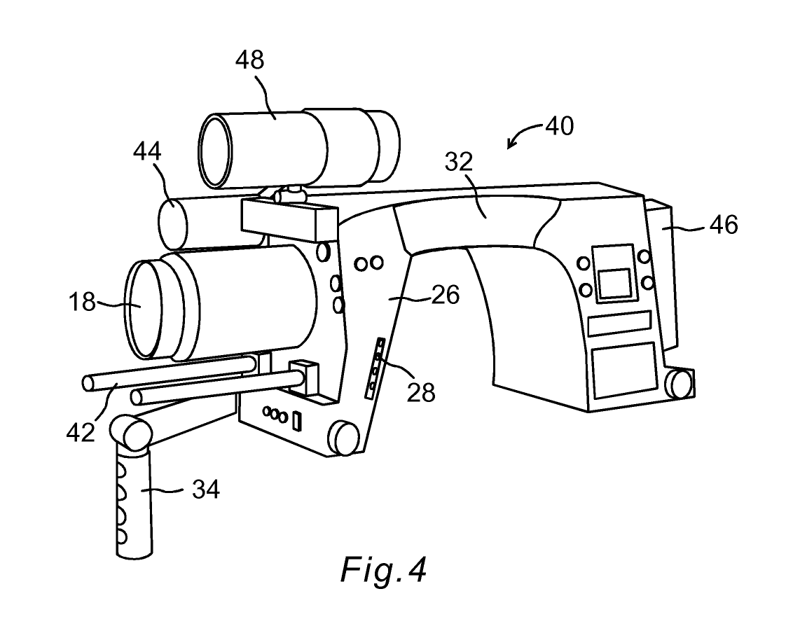

In the alternative embodiment of a camera housing 40 shown in FIG. 4 a handle 34 is provided to further facilitate the operation of the camera. The handle preferably is provided with controls for focus and zoom functions. Elements of the alternative embodiment of the camera housing that correspond to elements disclosed above are given the same reference numerals.

The alternative camera housing 40 also comprises front rods 42 that support further controls such as a follow focus. A microphone 44 is provided on the camera housing 40 and in this embodiment an external battery pack 46 is attached to the back portion. A viewfinder 48 is provided in a conventional manner on top of the camera housing.

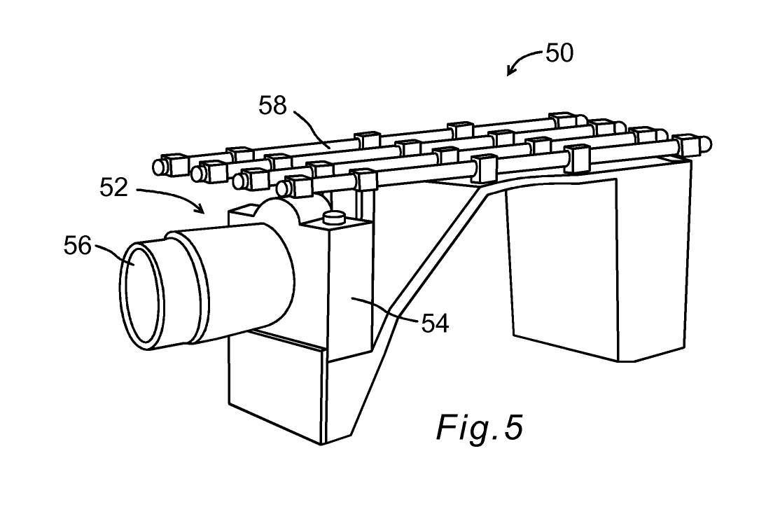

The very schematic view of FIG. 5 shows a simplified camera housing 50 supporting a camera 52. The camera 52 can be a single-lens reflex camera having a camera body 54 and a camera lens 56. A plurality of top rods 58 are provided for supporting any accessories that are used with the camera 52.

While certain illustrative embodiments of the invention have been described in particularity, it will be understood that various other modifications will be readily apparent to those skilled in the art without departing from the scope and spirit of the invention. Accordingly, it is not intended that the scope of the claims appended hereto be limited to the description set forth herein but rather that the claims be construed as encompassing all equivalents of the present invention which are apparent to those skilled in the art to which the invention pertains.

1. A camera housing configured to carry camera components and peripherals, said housing comprising a front portion, a back portion and an intermediate portion in between, the intermediate portion formed with an arched recess dimensioned to receive the shoulder of an operator, wherein a straight base line A extending substantially horizontally defines a top section of said recess in an operating position of the camera housing, and
the front portion and the back portion substantially are located below line A.

2. The camera housing as claimed in claim 1, wherein the camera housing has a center of gravity below line A.

3. The camera housing as claimed in claim 1, wherein said intermediate portion has a cut-in portion configured to receive the neck of the operator when the camera housing is carried on the shoulder of the operator.

4. The camera housing as claimed in claim 1, wherein said front portion includes an inclined surface extending from a top to a base, where the base is wider than the top.

5. The camera housing as claimed in claim 1, wherein a lens supporting means is provided below base line A.

6. The camera housing as claimed in claim 4, wherein the inclined surface of the front portion comprises controls configured to control a camera of the camera housing.

7. The camera housing as claimed in claim 1, wherein the front portion comprises a first lens and a second lens, wherein said first lens and said second lens are arranged to provide a three dimensional function of a camera of the camera housing.

8. The camera housing as claimed in claim 1, wherein a lens support is provided below base line A.
